(19) United States
(12) Patent Application Publication
(10) Pub. No.: US 2007/0007897 A1
(43) Pub. Date: Jan. 11, 2007

(54) Electromagnetic radiation sources and materials for their construction

(76) Inventor: Garth Wesley Billings, Reno, NV (US)

Correspondence Address: Garth W. Billings, 204 Edison Way, Reno, NV, 89502, US

(21) Appl. No.: 11/177,522

(22) Filed: Jul. 8, 2005

(51) Int. Cl. H01J 61/30; H01J 17/16; H01J 61/12

(52) U.S. Cl. 313/634; 313/493; 313/573

(57) ABSTRACT

Electromagnetic radiation sources and specific wavelength producing lamps are made from translucent to transparent doped ceramic materials or doped single crystal materials or doped glass materials used to form the lamp housing. The lamp housing contains an energy source or generator, e.g. produced by electric-arc ionization of an active ingredient, that allows for some of the light to be transmitted and some of the energy to be absorbed by and reemitted from the dopants in the transparent and absorbing-reemitting housing.

### BACKGROUND OF THE INVENTION

1. Field of the Invention

The present invention relates generally to electromagnetic radiation (or light) sources and materials and methods for their construction, and more particularly to electromagnetic discharge lamps, laser-lamps, infrared lamps, ultraviolet lamps, and specifically colored light sources.

2. Description of Related Art

In the field of high intensity lighting, numerous types of light sources are available. Incandescent-filament type lights are probably most common. Their efficacy (efficiency) is on the order of 5-10 lumens of light output per watt of input power, and the wavelengths of the light emitted are more in the yellow to red regions of the visible spectrum. By comparison, fluorescent-tube type lights generally have higher efficiencies, and produce a broader range of wavelengths, allowing them to produce more “white” and sometimes brighter light. Also, there are different types of discharge light sources, e.g. arc-lamps, utilizing electric-arc ionization of gases (e.g. xenon, argon, krypton, neon, and fluorides), metals (e.g. sodium and mercury) and numerous chemical compounds (including metal halides like metal-bromides and metal-iodides, especially rare earth iodides). Some are highly efficient (>50 lumens per watt), producing very high intensity light discharges, and in some cases, controlled wavelength emissions. Most of the light sources described above utilize lamp housings (or bulb enclosures, or envelopes) made of glass or fused silica, quartz, or translucent to transparent aluminum oxide in the form of either ceramics or hollow-single crystal sapphire, to contain the light emitting material, and to allow the emitted light to pass to the external environment.

In many cases, different light source lamp housings are coated with special materials that are functionally designed for selective absorption and transmittance, i.e. as filters; thus, these coatings absorb unwanted wavelengths of light, and allow for transmittance of the more desirable wavelengths of light. These coatings can be complex in material composition and thin-film architectures, but are typically materials like aluminum oxide, titanium dioxide, cerium oxide, magnesium fluoride, and other rare earth oxides and fluorides like lanthanum fluoride. Additionally, there are many different shapes, sizes, input/output powers, and specialized wavelength emission light sources offered and commercially available. Further, there are semiconductor diode-type light sources, e.g. light emitting diodes (LEDs), capable of generating high intensity light. Finally, there are many different types of lasers, both gas and solid state, produced for generating high-energy outputs of (coherent) electromagnetic radiation in almost all wavelengths of the electromagnetic spectrum. Lasers typically have resonant cavities.

In the past, “colored” lights have been produced using a variety of techniques, including by the use of selective absorption and transmittance coatings on or in the lamp housings. “Christmas” lights (coated bulb incandescent lamps) are a simple example, “neon” lights (electron-ionized neon lamps) are a little more advanced, and ultra-violet electric-arc ionized xenon and mercury vapor lamps are more complex and more relevant to this invention. Also relevant to this invention, and in general, solid-state lasers, made from doped single crystals like Al₂O₃:Cr³⁺ (“ruby”), Al₂O₃:Ti³⁺ (“Ti-sapphire”), neodymium doped yttrium aluminum garnet (“YAG:Nd³⁺”), and many other doped single crystals, require external energy sources for exciting their internal components, i.e. the dopants in the crystals, to the point that they re-emit some of the absorbed energy in the form of visible light or other wavelengths of electromagnetic radiation. In many lasers, a mercury-vapor ultraviolet arc-lamp or flashlamp is employed as the external energy source used to excite or “pump” the laser ion dopants inside the crystal, thereby causing the crystal to lase. LEDs are also often used to pump solid state lasers. Lasers typically emit coherent, monochromatic beams of light.

### SUMMARY OF THE INVENTION

Accordingly, it is an object of the invention to provide high intensity electromagnetic radiation (light) sources, that efficiently emit specific wavelengths, or colors, of light, and to provide improved materials and designs and methods for construction of such electromagnetic radiation sources. As used herein, the term “light” is broadly construed to cover visible light as well as electromagnetic radiation of other wavelengths.

The invention is an electromagnetic radiation (or light) source having a source housing (or body or enclosure or envelope) constructed, at least partly, from a class of doped ceramic materials or doped single crystal materials or doped glass materials and enclosing an internal energy source or generator of radiation. The doped materials are selected to emit radiation (light) at specific and controlled wavelengths and energies when excited by the radiation from the generator, or to selectively absorb and transmit the radiation produced by the generator so that specific and controlled wavelengths and energies are obtained from the source, or both.

The energy to excite the doped materials is generated internally to the housing. Some of the energy produced inside the source housing passes through the enclosure, and some of the energy is absorbed by the doped housing material, thereby stimulating the dopants in the housing materials to re-emit radiation (light) at specific and controlled wavelengths and energies. Alternately the doped housing material selectively transmits desired wavelengths and absorbs undesired wavelengths. Further, the housing materials may perform both functions, acting as both an emitter and as a filter. The output radiation is partially controlled by the housing's physical and chemical properties in combination with the type of energy source. The energy source is typically an electric-arc that activates elemental or chemical ingredients enclosed in the housing to create a plasma. The materials used to form these electromagnetic radiation source housings are either transparent to translucent doped single crystals, or are translucent to transparent doped ceramic materials, or are transparent to translucent doped glasses. The materials have been machined or otherwise shaped and assembled by hermetic sealing techniques to form the housings. Alternatively these materials can be used as coatings or layers, either internal or external, on other housing materials, e.g., sapphire, translucent alumina, quartz, and glass.

An aspect of the invention is an electromagnetic radiation source with a housing having at least a transparent or translucent portion thereof made at least partly of a doped material, and an electromagnetic radiation generator in the housing to generate electromagnetic radiation which enters the doped material of the housing. The doped material is selected to produce electromagnetic radiation of a desired color from the electromagnetic radiation entering the housing from the generator, the radiation of a desired color being output by the source.

Another aspect of the invention is an electromagnetic radiation source with a transparent or translucent cylindrical housing including a doped material, and an electromagnetic radiation generator in the housing to generate electromagnetic radiation that enters the housing. The doped material is selected to convert the electromagnetic radiation from the generator into electromagnetic radiation of a desired color.

A further aspect of the invention is an electromagnetic radiation source with a transparent or translucent housing made at least partly of a doped material, and electromagnetic radiation generating means in the housing for generating electromagnetic radiation which enters the doped material of the housing. The doped material is selected to convert the electromagnetic radiation from the generating means into electromagnetic radiation of a desired color.

### BRIEF DESCRIPTION OF THE DRAWINGS

FIGS. 1-2 are longitudinal and axial sectional views, respectively, of an electromagnetic radiation source of the invention with a housing made entirely of the doped ceramic or single crystal or glass materials.

FIGS. 3-4 are axial sectional views of alternate electromagnetic radiation source housings of the invention, having an external and internal surface of the doped ceramic or single crystal or glass materials, respectively.

FIG. 5 is an axial sectional view of a radiation source housing of the invention with a partial shield.

FIGS. 6-7 are longitudinal and axial sectional views, respectively, of an alternate embodiment of an electromagnetic radiation source of the invention.

### DETAILED DESCRIPTION OF THE INVENTION

The electromagnetic radiation source (or light source, where “light” is defined to encompass visible and nonvisible electromagnetic radiation) of the invention is formed of an electromagnetic radiation generating apparatus, such as an arc lamp, in a housing made, at least partly, of a material selected to produce a desired color output. A desired color refers to radiation or light of a single wavelength or a number of wavelengths; the colors may be in the visible spectrum or may be outside. The housing material is a doped transparent to translucent ceramic or a doped single crystal or a doped glass.

In a primary aspect of the invention, the housing material functions as an emitter, and converts the radiation produced by the internal electromagnetic generating apparatus into the desired colors, by either up conversion or down conversion. In this aspect of the invention, the dopants in the housing material are excited by the incident radiation and re-emit at a different wavelength. “Down Conversion” is a process in which the wavelength is lengthened (and the frequency is decreased) while “Up Conversion” is a process which does the opposite, shortening wavelength (and increasing frequency).

In another aspect of the invention, the housing material functions as a filter which passes the desired color produced by the internal source and absorbs the other colors, so that only the desired color is obtained from the source. In a third aspect of the invention, the housing material functions as both an emitter and as a filter, e.g. emitting a desired color after absorbing some of the light from the internal source while filtering out other light from the internal source.

Additional effects may also be produced by the housing material. For example, lanthanum hexaboride (LaB₆) is also an excellent electron emitter. Thus it could be used to produce light of a certain color, e.g. purple, while also providing a source of electrons.

According to the invention, these doped ceramic, crystal, and glass materials can be engineered and produced to provide high temperature and corrosion resistance, selective absorption and transmittance, fluorescence and luminescence, and a variety of colors and color densities; and many of the compounds can be modified for other desirable properties.

The invention can be implemented with a wide variety of materials; virtually any doped transparent to translucent ceramic or doped single crystal or doped glass which produces the desired color for a particular application can be used. The material must of course transmit or emit light, and must be reasonably compatible with the temperatures and chemistries utilized by the internal energy source. For any particular internal radiation source, the material is selected to interact with that radiation to produce a desired output.

The doped single crystal, glass, or ceramic compounds are materials including doped oxides, doped aluminates, doped gallates, doped borates, doped borides, doped nitrides, doped oxynitrides, doped vanadates, doped tantalates, doped niobates, doped sulfides, doped oxysulfides, doped fluorides, doped oxyfluorides, doped silicates, doped germanates, doped phosphates, and doped phosphosilicates.

The materials may include known laser materials, i.e. known laser ion dopants in known laser host materials. However, the present invention is not a laser since there is no resonator, and unlike lasers that produce coherent radiation, the present invention does not, i.e. the output is not coherent. The present invention is thus a type of lamp, and not a laser.

A preferred material of this type is chromium doped sapphire or ruby, i.e. Cr³⁺:Al₂O₃. Another material is titanium doped sapphire, i.e. Ti³⁺:Al₂O₃. These materials are well known laser materials.

The materials also include but are not limited to doped binary rare earth (RE) oxides. These materials have the formula Ln:RE₂O₃ where RE is a Group IIIB element, i.e. Sc, Y, or a lanthanide La through Lu, and the dopant Ln is another Group IIIB element (Sc, Y, or a lanthanide). As examples, the dopants include Ce, Pr, Nd, Sm, Eu, Gd, Tb, Dy, Ho, Er, Tm, Yb, and Lu and the rare earth oxides include Y₂O₃, Gd₂O₃, and Lu₂O₃. Ytterbium doped yttria, Yb:Y₂O₃, is a particular illustrative material.

Other doped binary oxides, fluorides, and other compounds can also be used. An example is a Group IIA metal (Be, Mg, Ca, Sr, Ba) fluoride doped with a Group IIIB metal (Sc, Y, and lanthanides La through Lu) fluoride, e.g. SrF₂:Nd

The materials of the invention also comprise a class of ternary oxides and fluorides, including but not limited to: 1) Group IIIA metal oxides (M=B, Al, Ga, In, Tl) (e.g. Al₂O₃, Ga₂O₃, In₂O₃, Tl₂O₃) reacted with Group IIIB metal oxides (M′=Sc, Y, and lanthanides La through Lu) to form garnet crystal materials like yttrium aluminum garnet (Y₃Al₅O₁₂) or gadolinium gallium garnet (Gd₃Ga₅O₁₂), with these “garnet” materials being doped with another lanthanide additive like cerium, praseodymium, neodymium, samarium, europium, terbium, dysprosium, holmium, erbium, thulium, ytterbium, lutetium, or other functional material like cobalt or chromium; 2) Group IIIB metal oxides (M′=Sc, Y, and lanthanides La through Lu) reacted with Group VB metal oxides (M″=V, Nb, Ta) to form vanadates, niobates, or tantalates, with these materials being doped with another lanthanide additive, or other functional material, e.g., YVO₄:Nd, LuTaO₄:Eu; 3) Group IA metal oxides (M*=Li, Na, K, Rb, Cs) reacted with Group VB metal oxides (M″=V, Nb, Ta) to form tantalates, niobates, or vanadates like LiTaO₃, LiNbO₃, or LiVO₃; 4) Group IIIA metal oxides (M=B, Al, Ga, In, Tl) reacted with Group IIA metal oxides (M**=Be, Mg, Ca, Sr, Ba) to form spinel crystal or crystalline materials like MgAl₂O₄ doped with additives like cobalt as in Co:MgAl₂O₄, or vanadium as in V:BeAl₂O₄; 5) Group IA metal fluorides (M*=Li, Na, K, Rb, Cs) reacted with Group IIIB metal fluorides (M′=Sc, Y, and lanthanides La through Lu) forming ternary fluorides, e.g., LiYF₄, KGdF₄; 6) Group IIA metal fluorides (M**=Be, Mg, Ca, Sr, Ba) reacted with Group IIIB metal fluorides (M′=Sc, Y, and lanthanides La through Lu), e.g. SrF₂:Nd; 7) Group IIIB metal oxides (M′=Sc, Y, and lanthanides La through Lu) reacted with Group IVA Oxides (M***=Si, Ge, Sn, Pb) to form silicates germinates, stannates, and plumbates, e.g. Lu₂SiO₅:Ce, Gd₂PbO₅:Pr, Er₂GeO₅:Eu. The second through seventh subgroups also contain similar dopants to those described with the first subgroup. The ternary compounds may be made by any other method in addition to the reaction of the binary compounds indicated above.

All of the materials in the above seven subgroups are encompassed by the general formula X:Mₓ₁M′ₓ₂M″ₓ₃M*ₓ₄M**ₓ₅M***ₓ₆O_{y}F_{z} where X is the dopant and two of x1, x2, x3, x4, x5, and x6 are not zero, and y or z is not zero. These include the more specific formulas Mₓ₁M′ₓ₂O_{y}, M′ₓ₂M″ₓ₃O_{y}, M*ₓ₄M″ₓ₃O_{y}, Mₓ₁M**ₓ₅O_{y}, M′ₓ₂M***ₓ₆O_{y}, M**ₓ₅M′ₓ₂F_{z}, and M*ₓ₄M′ₓ₂F_{z} where each of xn (n=1 . . . 6), y, z>0, i.e. the seven subgroups specifically encompass the general formula with the specific combinations x1, x2, y all>0, the rest=0; x2, x3, y all>0, the rest=0; x4, x3, y all>0, the rest=0; x1, x5, y all>0, the rest=0; x2, x6, y all>0, the rest=0; x5, x2, z all>0, the rest=0; and x4, x2, z all>0, the rest=0. Any of the materials can be doped with other activators and mixtures thereof.

The materials also include doped glass, particularly deeply doped colorful laser glass. The dopants are similar to those already described above, including particularly rare earths, cobalt, and chromium. The glasses include silicates, fluorosilicates, borates, fluoroborates, germinates, stannates, phosphates, phosphosilicates, fluorophosphates, and fluorophosphosilicates.

Many different materials can be used for the dopants. Crystal materials are more limited in the amount of dopants, typically from a few tenths up to several gram mole %. Ceramics and glasses can contain much more dopant, from a few tenths up to more than 25 gram mole %.

Generally, the colored radiation sources of the invention can be implemented with a wide variety of materials. For a particular internal source generator, producing radiation of one or more wavelengths, any dopant in any ceramic, single crystal, or glass host material can be used which produces the desired color output.

Preferred embodiments of the invention include aluminum oxide doped with chromium oxide, aluminum oxide doped with titanium oxide, magnesium aluminate doped with cobalt oxide, lanthanide oxides doped with lanthanide oxides, lanthanide aluminates doped with lanthanide oxides, lanthanide gallates doped with lanthanide oxides, beryllium aluminate doped with vanadium oxide or chromium oxide, lanthanide vanadates doped with lanthanide oxides, lanthanide fluorides doped with lanthanide fluorides, alkaline earth fluorides doped with lanthanide fluorides, lanthanide silicates doped with lanthanide oxides. While the dopants are listed here as oxides or fluorides, the form in which they are physically added, it is the cation that is the active dopant, as usually indicated previously.

The single crystal materials fabricated and assembled into housings of this invention, many of which are commercially available, are typically grown by means of Czochralski or Bridgeman crystal growing techniques. Translucent to transparent ceramic materials of this invention can be made by a variety of different techniques, including but not limited to:

1. Solid-state reaction synthesis and high temperature sintering. Powders (nanomaterials) of the binary compounds are weighed in precise gram molecular weights and blended together. Then they are formed into parts by means of conventional isostatic compaction, extrusion, injection molding, slip casting, tape casting, vacuum hot pressing, hot isostatic pressing, and hydraulic pressing techniques, then processed in high temperature furnace systems to first react the components to form the final compound, followed by high temperature sintering to produce fully dense, translucent to transparent ceramic pieces.

These techniques generally involve four factors: powder chemistry, powder size, forming technique, and high temperature process (sintering). The powders are preferably nanometer size, e.g. 10-250 nm.

2. Other techniques like sol-gel, filtration, precipitation and co-precipitation can also be used in the fabrication.

The crystalline compounds and glass materials can be made by well known conventional processes. Doping is also performed by well known conventional processes, e.g. mixing dopant powders with the other powders prior to synthesis and sintering or melting. While the dopant is generally identified by the active element (or ion), it is usually added in the form of a compound, e.g. an oxide of the active element (ion).

The lamp housings, or a portion thereof, can be made entirely of the disclosed doped ceramics or crystals or glasses, or these materials may be applied as coatings or layers on other host materials. These housings, made of or coated with the above-described materials, form a part of the invention. The housings are fabricated and assembled by well known techniques as are presently used to make conventional lamps. The difference is the material of which the housings are made.

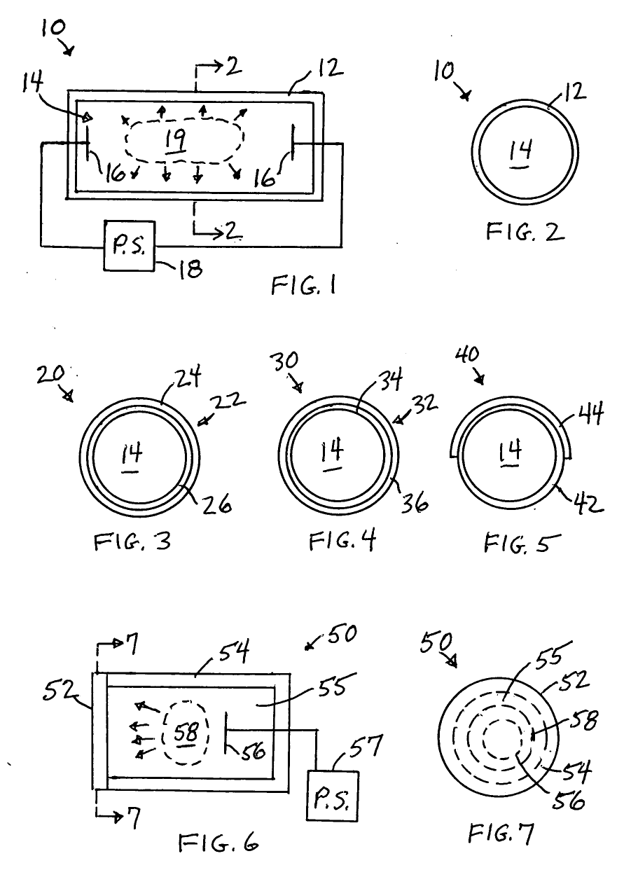

An arc-lamp 10 according to the invention is shown in FIGS. 1-2. The arc-lamp 10 is formed of an arc-lamp housing 12 that is formed of a sealed hollow shaped body, typically cylindrical in shape (as shown), but not limited to any particular shape. An energy source (or electromagnetic energy (EMR) generator) 14, e.g. a xenon-mercury vapor plasma energy source, is contained in the arc-lamp housing 12. The energy source 14 is formed of a pair of electrodes 16 positioned inside the arc-lamp housing 12 and electrically connected to an external power source 18. Energy source 14 also includes an excitable material, e.g. Hg/Xe, which is excited by the power source 18 to produce a plasma 19 which emits electromagnetic radiation which enters into the housing 12.

The active energy source or generating means inside the lamp of the invention can be any source that produces radiation from which the lamp housing produces light of the desired color. The active energy source can be Xe—Ar, and plasma generated by electron ionized materials, including Hg, HgBr, and methyl bromide. For example, the energy source may use electric-arc ionized metals like mercury vapor, electric-arc ionized gases like xenon, neon, argon, or krypton, or a combination of electric-arc ionized Hg/Xe, electric-arc ionized metallic alloys like BiHg, electric-arc ionized metal halides like lanthanide iodides (LnI₃), or electric-arc ionized halide gases like KrF, XeF, and ArF, or electron-photon discharge. The arcs may be AC or DC. The electrodes 16 are typically made of refractory metal, i.e. W, Re, Mo, Ta, Nb, or alloys thereof.

The arc-lamp housing 12 of FIGS. 1-2 is formed entirely of the doped ceramic or crystal materials. An alternate arc-lamp 20 shown in FIG. 3 is formed of an arc-lamp housing 22 that has an external surface layer or coating 24 of the doped ceramic or single crystal materials and an internal body 26 of other materials (e.g. SiO₂, Al₂O₃). An alternate arc-lamp 30 shown in FIG. 4 is formed of an arc-lamp housing 32 that has an internal surface layer or coating 34 of the ceramic materials and an external body 36 of other materials (e.g. SiO₂, Al₂O₃). Except for the difference in the construction of the housings 12, 22, 32, arc-lamps 20, 30 are similar to arc-lamp 10, containing an energy source 14 therein, and have a configuration similar to FIG. 1. The housing bodies or substrates 26, 36 may be made of many different materials, e.g. sapphire, translucent alumina, quartz, and glass.

While the light sources or lamps 10, 20, 30 described above emit light in a full 360 pattern around the longitudinal axis of the cylindrical housing, the direction of the emitted light can be limited or focused by the use of absorber or reflector shields. As shown in FIG. 5, lamp 40 has a housing 42 enclosing an energy source 14; housing 40 may be similar to any of housings 12, 22, 32 previously described and lamp 40 is similar to lamps 10, 20, 30. Lamp 40 also has a shield 44 positioned adjacent to housing 42 to prevent light from lamp 40 from being emitted in certain directions. Shield 44 is typically a reflector, and may be formed as a coating directly on a portion of housing 42 or may be placed in close proximity to the housing 42.

While the invention has been described with respect to embodiments with cylindrically shaped housings made of the described materials, the invention is not limited to a particular shape. Also, the entire housing does not have to be made of the described materials, only the portion from which the colored light is to be obtained. FIGS. 6-7 illustrates a lamp 50 having a flat window 52 made of the described doped materials positioned at and closing the end of a lamp body 54. Lamp body 54 is opaque (or has a reflective inner surface) and defines a cavity 55 which contains the light generating apparatus. The light generating apparatus includes an electrode or antenna 56 connected to a power source 57. Cavity 55 also contains a gas or other material that is excited by electrode or antenna 56 to produce a plasma 58 which emits radiation. Window 52 produces the light of desired color from this internally generated radiation, as above. Window 52 may be made entirely of the disclosed doped materials or may also be formed of a coating on a substrate.

The invention as described can be used to make lamps of many different sizes. For example, the sources can be made miniature, e.g. 3 mm long, or can be made large, e.g. 1 m long. The parts can be assembled, filled, and sealed to make the lamps by known techniques. With the proper dosages of ionization chemicals, and fill pressures, into the generator body, efficacies exceeding 20-50 lumens per watt should be achievable.

The light sources or lamps of the invention have practical utility for many purposes, including but not limited to colored display lighting, Casino and Christmas tree lights, infrared heat lights, infrared countermeasure lamps, ultraviolet polymer curing lights, ultraviolet medical lamps, ultraviolet sterilization lamps, laser pump lamps, and many others.

Changes and modifications in the specifically described embodiments can be carried out without departing from the scope of the invention which is intended to be limited only in scope of the appended claims.

The invention claimed is:

1. An electromagnetic radiation source comprising:
a housing having at least a transparent or translucent portion thereof made at least partly of a doped material;
an electromagnetic radiation generator in the housing to generate electromagnetic radiation which enters the doped material of the housing;
wherein the doped material is selected to produce electromagnetic radiation of a desired color from the electromagnetic radiation entering the housing from the generator, the radiation of a desired color being output by the source.

2. The source of claim 1 wherein the doped material is selected from doped ceramic, doped single crystal, and doped glass.

3. The source of claim 1 wherein the doped material is a doped ceramic.

4. The source of claim 1 wherein the doped material is a doped single crystal.

5. The source of claim 1 wherein the doped material is a doped glass.

6. The source of claim 1 wherein the electromagnetic radiation generator in the housing is an arc lamp apparatus.

7. The source of claim 1 wherein the housing comprises a cylinder made of the doped material.

8. The source of claim 1 wherein the housing comprises a cylinder made of a transparent or translucent substrate material with an internal or external coating of the doped material.

9. The source of claim 1 wherein the doped material is a material which is excited by the radiation from the generator and emits radiation of the desired color as a result thereof.

10. The source of claim 1 wherein the doped material is a material which absorbs some, most, or all the radiation from the generator and re-emits radiation of the desired wavelengths.

11. The source of claim 1 wherein the doped material is selected from doped oxides, doped aluminates, doped gallates, doped borates, doped borides, doped nitrides, doped oxynitrides, doped vanadates, doped tantalates, doped niobates, doped sulfides, doped oxysulfides, doped fluorides, doped oxyfluorides, doped silicates, doped phosphates, and doped phosphosilicates.

12. An electromagnetic radiation source comprising:
a transparent or translucent cylindrical housing comprising a doped material;
an electromagnetic radiation generator in the housing to generate electromagnetic radiation which enters the housing;
wherein the doped material is selected to convert the electromagnetic radiation from the generator into electromagnetic radiation of a desired color.

13. The source of claim 12 wherein the doped material is selected from doped ceramic, doped single crystal, and doped glass.

14. The source of claim 13 wherein the housing comprises a cylinder made of the doped material or the housing comprises a cylinder made of a transparent or translucent substrate material with an internal or external coating of the doped material.

15. The source of claim 14 wherein the electromagnetic radiation generator in the housing is an arc lamp apparatus.

16. The source of claim 12 wherein the doped material is selected from aluminum oxide doped with chromium oxide, aluminum oxide doped with titanium oxide, magnesium aluminate doped with cobalt oxide, lanthanide oxides doped with lanthanide oxides, lanthanide aluminates doped with lanthanide oxides, lanthanide gallates doped with lanthanide oxides, beryllium aluminate doped with vanadium oxide or chromium oxide, lanthanide vanadates doped with lanthanide oxides, lanthanide fluorides doped with lanthanide fluorides, alkaline earth fluorides doped with lanthanide fluorides, lanthanide silicates doped with lanthanide oxides.

17. An electromagnetic radiation source comprising:
a transparent or translucent housing made at least partly of a doped material;
electromagnetic radiation generating means in the housing for generating electromagnetic radiation which enters the doped material of the housing;
wherein the doped material is selected to convert the electromagnetic radiation from the generating means into electromagnetic radiation of a desired color.

18. The source of claim 17 wherein the doped material is selected from doped ceramic, doped single crystal, and doped glass.

19. The source of claim 17 wherein the housing comprises a cylinder made of the doped material or made of a transparent or translucent substrate material with an internal or external coating of the doped material, and the generating means is an arc lamp apparatus.

20. The source of claim 17 wherein the doped material is selected from aluminum oxide doped with chromium oxide, aluminum oxide doped with titanium oxide, magnesium aluminate doped with cobalt oxide, lanthanide oxides doped with lanthanide oxides, lanthanide aluminates doped with lanthanide oxides, lanthanide gallates doped with lanthanide oxides, beryllium aluminate doped with vanadium oxide or chromium oxide, lanthanide vanadates doped with lanthanide oxides, lanthanide fluorides doped with lanthanide fluorides, alkaline earth fluorides doped with lanthanide fluorides, lanthanide silicates doped with lanthanide oxides.
